(19) United States
(12) Patent Application Publication
(10) Pub. No.: US 2024/0134223 A1
(43) Pub. Date: Apr. 25, 2024

(54) DISPLAY DEVICE AND METHOD FOR MANUFACTURING DISPLAY DEVICE

(71) Applicant: Japan Display Inc., Tokyo (JP)

(72) Inventors: Shuichi OSAWA, Tokyo (JP); Yoshikatsu IMAZEKI, Tokyo (JP); Yoichi KAMIJO, Tokyo (JP); Koichi MIYASAKA, Tokyo (JP); Yoshifumi KAMEI, Tokyo (JP)

(21) Appl. No.: 18/379,340

(22) Filed: Oct. 11, 2023

(30) Foreign Application Priority Data
Oct. 18, 2022 (JP) 2022-167785

(51) Int. Cl. G02F 1/1335; B32B 7/12; B32B 37/10; B32B 37/12

(52) U.S. Cl. CPC G02F 1/133514; B32B 7/12; B32B 37/10; B32B 37/12; B32B 2037/1253; B32B 2457/202; G02F 2202/28

(57) ABSTRACT

A display device includes a display panel, a color separation element configured to disperse light from a light source and to emit, to the display panel, a plurality of rays of separated light with wavelengths different from each other, and an adhesive portion that contains a gap member of a given size and that bonds the display panel to the color separation element. The adhesive portion has a recessed portion that is separated from one of the display panel and the color separation element in side view.

### CROSS-REFERENCE TO RELATED APPLICATION

This application claims the benefit of priority from Japanese Patent Application No. 2022-167785 filed on Oct. 19, 2022, the entire contents of which are incorporated herein by reference.

### BACKGROUND

### 1. Technical Field

The present disclosure relates to a display device and a method for manufacturing the display device.

### 2. Description of the Related Art

The display device in Japanese Patent Application Laid-open Publication No. H10-319217 (JP-A-H10-319217) includes a liquid crystal display panel having pixels, a color separation element, and a surface light source device that irradiates the color separation element with light. The color separation element separates light from the surface light source device into beams of light in colors different from each other and focuses the beams of light on the pixels of the display panel.

In the display device in JP-A-H10-319217, the display panel and the color separation element desirably have an air layer therebetween so that the pixels are irradiated with the light from the color separation element. The color separation element is bonded to the display panel with an adhesive, for example. The adhesive is applied around a display region of the display panel where images are displayed.

The adhesive is desirably not applied continuously around the entire perimeter of the display region of the display panel, but applied with a gap. Without the gap, air surrounded by the adhesive between the display panel and the color separation element is compressed, and the display panel and the color separation element may be deformed. Foreign matter may enter through the gap.

It is an object of the present disclosure to provide a display device and a method for manufacturing the display device that can suppress foreign matter's entry.

### SUMMARY

A display device according to the present disclosure includes a display panel, a color separation element configured to disperse light from a light source and to emit, to the display panel, a plurality of rays of separated light with wavelengths different from each other, and an adhesive portion that contains a gap member of a given size and that bonds the display panel to the color separation element. The adhesive portion has a recessed portion that is separated from one of the display panel and the color separation element in side view.

A method for manufacturing a display device is disclosed. The method includes applying an adhesive containing a gap member of a given size to a board surface of a display panel, sticking together a board surface of a color separation element and the board surface of the display panel with the adhesive between the board surfaces, the board surface of the color separation element dispersing light from a light source and emitting a plurality of rays of separated light with wavelengths different from each other, applying force to press the gap member against the color separation element and the display panel, the color separation element and the display panel being stuck to each other with the adhesive, curing part of the adhesive while the force is applied to the color separation element and the display panel, removing the force while the part of the adhesive has cured, and curing the entire adhesive while the force is removed from the color separation element and the display panel.

### BRIEF DESCRIPTION OF THE DRAWINGS

FIG. 1 is a plan view of a display device according to an embodiment of the present disclosure;

FIG. 2 is a sectional view of the display device;

FIG. 3 is a view illustrating a circuit configuration of a display panel;

FIG. 4 is a sectional view of the display panel;

FIG. 5 is a sectional view of a color separation element;

FIG. 6 is an enlarged sectional view of the color separation element;

FIG. 7 is a side view of the display device;

FIG. 8 is a perspective view illustrating the display panel to which an adhesive has been applied at an application step;

FIG. 9 is a perspective view illustrating the color separation element and the display panel being stuck together at a sticking step;

FIG. 10 is a side view illustrating force F being applied to the display panel and the color separation element at a pressing step;

FIG. 11 is a side view illustrating part of the adhesive being irradiated with ultraviolet light at a first curing step;

FIG. 12 is a side view illustrating the force F removed from the display panel and the color separation element at an unloading step; and

FIG. 13 is a side view illustrating a display device according to a modification of the embodiment of the present disclosure.

### DETAILED DESCRIPTION

Embodiments of the present disclosure will be described below with reference to the drawings. The present disclosure is not limited by what is described in the following embodiments. Components described below include those that can be easily assumed by a person skilled in the art and those that are substantially the same. Furthermore, the components described below can be combined as appropriate.

What is disclosed herein is merely an example, and any appropriate modification that would be easily conceived of by a person skilled in the art, while maintaining the purport of the present disclosure, is naturally included in the scope of the present disclosure. The drawings may schematically illustrate the width, thickness, shape, and the like of each part compared to the actual mode for the sake of clarity of explanation, but this is merely an example and does not limit the interpretation of the present disclosure. In the present specification and the drawings, elements similar to those described previously with respect to the drawings already mentioned are given the same reference signs and the detailed description thereof may be omitted as appropriate.

The X and Y directions illustrated in the drawings are orthogonal to each other and parallel to a main surface of a substrate included in a display device 1. The +X and −X sides in the X direction and the +Y and −Y sides in the Y direction correspond to the sides of the display device 1. The Z direction is orthogonal to the X and Y directions and corresponds to the thickness direction of the display device 1. The +Z side in the Z direction corresponds to the front surface side where an image is displayed in the display device 1, and the −Z side in the Z direction corresponds to the rear surface side of the display device 1.

In the present specification, “plan view” refers to viewing the display device 1 from the +Z side to the −Z side along the Z direction. In the present specification, “side view” refers to viewing the display device 1 from the sides of the display device 1 along a direction orthogonal to the Z direction. The X, Y, and Z directions are examples, and the present disclosure is not limited to these directions.

Display Device 1

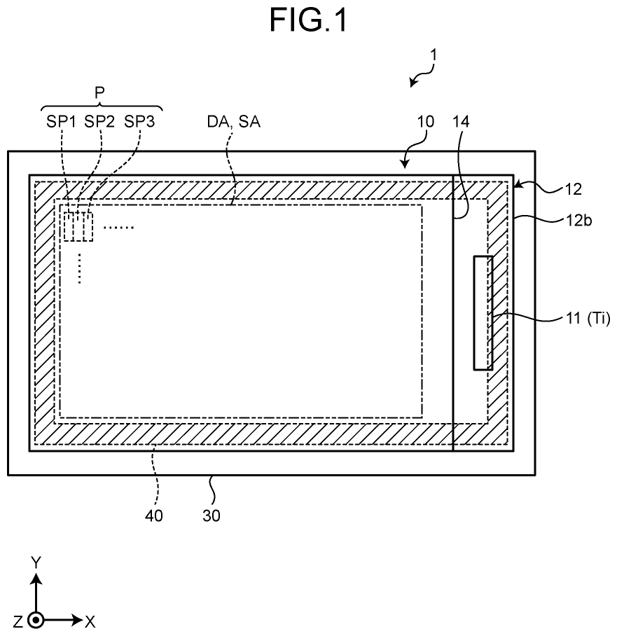

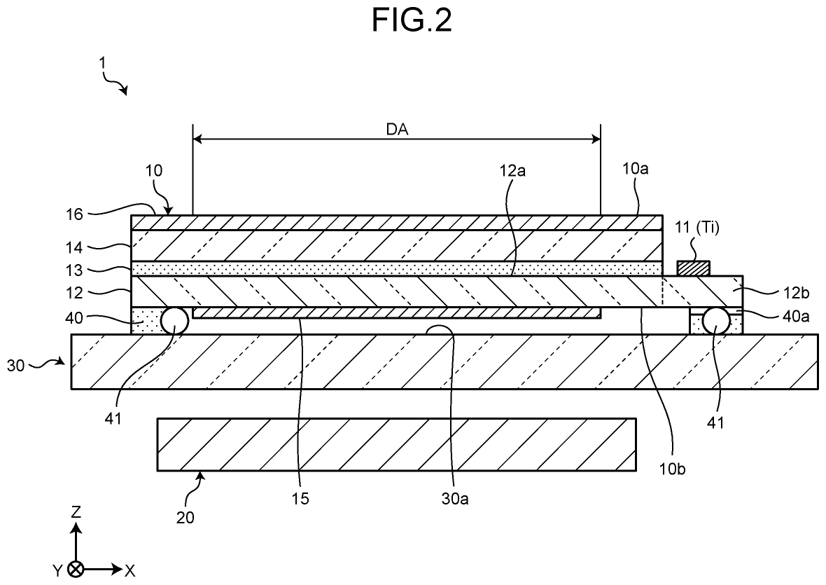

FIG. 1 is a plan view of the display device 1 according to an embodiment of the present disclosure. FIG. 2 is a sectional view of the display device 1. The display device 1 displays images on the basis of image signals output from an external device (not illustrated) that is electrically coupled through a flexible wiring board (not illustrated).

The display device 1 is applied, for example, to a head-up display. The head-up display projects an image onto a translucent object, such as a vehicle windshield, to allow a user to see a virtual image. The display device 1 includes a display panel 10, a light source device 20, a color separation element 30, and an adhesive portion 40. The light source device 20, the color separation element 30, and the display panel 10 are aligned in this order along the Z direction from the −Z side to the +Z side.

The display panel 10 is a transmissive liquid crystal display. The display panel 10 may be, for example, an organic electroluminescent (EL) display and an inorganic EL display. As illustrated in FIGS. 1 and 2, the front surface of the display panel 10 has a display region DA where images are displayed. As illustrated in FIG. 2, the front surface of the display panel 10 corresponds to a display surface 10a where images are displayed. The rear surface of the display panel 10 on the opposite side of the display surface 10a corresponds to an opposite surface 10b. As illustrated in FIG. 1, the display panel 10 includes a plurality of pixels P aligned in a matrix (row-column configuration) along the X and Y directions in the display region DA.

The pixels P each have a first sub-pixel SP1, a second sub-pixel SP2, and a third sub-pixel SP3. The first sub-pixel SP1 is a red sub-pixel. The second sub-pixel SP2 is a green sub-pixel. The third sub-pixel SP3 is a blue sub-pixel. The first sub-pixel SP1, the second sub-pixel SP2 and the third sub-pixel SP3 are aligned in this order along the X direction. The array of the first sub-pixel SP1, the second sub-pixel SP2 and the third sub-pixel SP3 is what is called a stripe array. Hereinafter, when the first sub-pixel SP1, the second sub-pixel SP2, and the third sub-pixel SP3 are described without distinction, they may simply be described as a “sub-pixel SP”. Not to mention, the array of sub-pixels SP is not limited to a stripe array, and the colors of sub-pixels SP are not limited to the aforementioned colors.

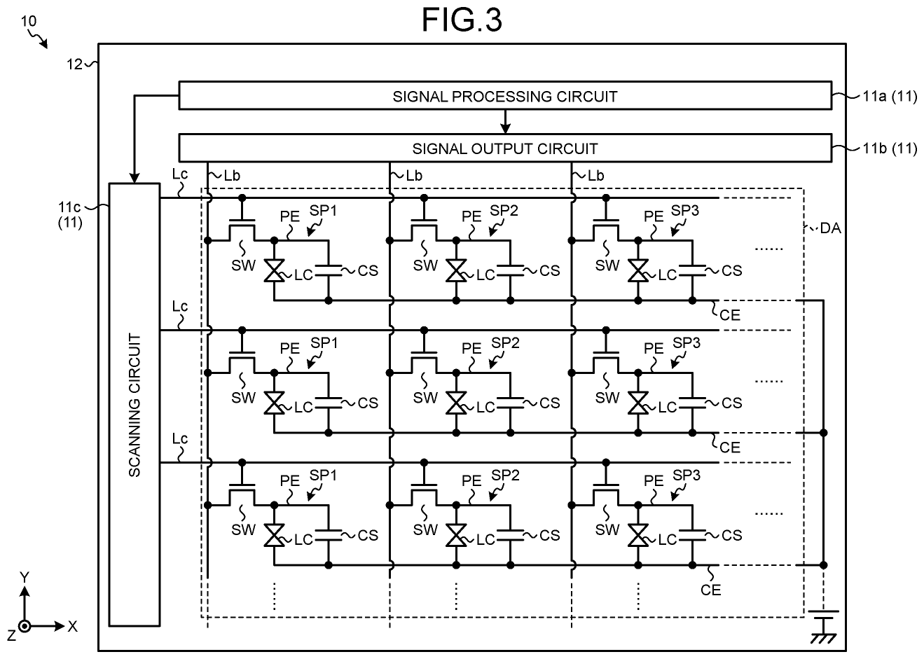

FIG. 3 is a view illustrating a circuit configuration of the display panel 10. The display panel 10 includes a drive circuit 11, as well as a switching element SW, a sub-pixel electrode PE, a common electrode CE, a liquid crystal capacitance LC, and a holding capacitance CS that are included in each of a plurality of the sub-pixels SP.

The drive circuit 11 drives the pixel P. The drive circuit 11 includes a signal processing circuit 11a, a signal output circuit 11b, and a scanning circuit 11c.

The signal processing circuit 11a outputs sub-pixel signals indicating gradations of the sub-pixels SP to the signal output circuit 11b on the basis of image signals transmitted from the external device. The signal processing circuit 11a outputs clock signals to the signal output circuit 11b and the scanning circuit 11c to synchronize the operation of the signal output circuit 11b with that of the scanning circuit 11c.

The signal output circuit 11b outputs the sub-pixel signals to the sub-pixels SP. The signal output circuit 11b and the sub-pixels SP are electrically coupled through a plurality of signal lines Lb extending along the Y direction.

The scanning circuit 11c scans the sub-pixels SP in synchronization with the output of the sub-pixel signals by the signal output circuit lib. The scanning circuit 11c and the sub-pixels SP are electrically coupled through a plurality of scanning lines Lc extending along the X direction.

The switching element SW includes a thin-film transistor (TFT), for example. In the switching element SW, a source electrode is electrically coupled to the signal line Lb, and a gate electrode is electrically coupled to the scanning line Lc.

The sub-pixel electrode PE is coupled to a drain electrode of the switching element SW. A plurality of the common electrodes CE are arranged corresponding to the scanning lines Lc. The sub-pixel electrode PE and the common electrode CE are translucent.

The liquid crystal capacitance LC is a capacitive component of a liquid crystal material in a liquid crystal layer 13, which will be described below, between the sub-pixel electrode PE and the common electrode CE. The holding capacitance CS is placed between an electrode with the same potential as the common electrode CE and an electrode with the same potential as the sub-pixel electrode PE.

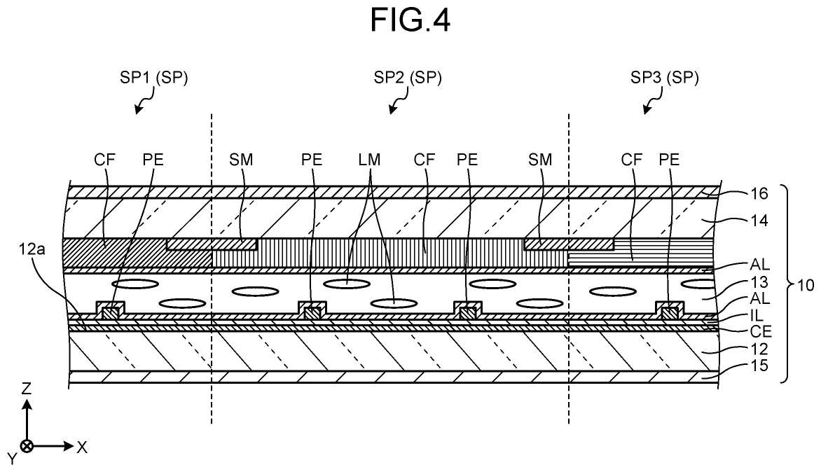

FIG. 4 is a sectional view of the display panel 10. The sub-pixel SP further includes a first substrate 12, the liquid crystal layer 13, and a second substrate 14. The first substrate 12, the liquid crystal layer 13, and the second substrate 14 are all translucent and are aligned in this order along the Z direction from the −Z side to the +Z side.

The first substrate 12 is rectangular in plan view and one first substrate 12 is provided for a plurality of the sub-pixels SP. The common electrode CE is placed on a main surface 12a on the +Z-side of the first substrate 12. An insulating layer IL is placed on the front surface of the common electrode CE, and the sub-pixel electrode PE and an orientation film AL are further placed.

The sub-pixel electrode PE is placed between the insulating layer IL and the orientation film AL. In this manner, the common electrode CE is placed on, and the sub-pixel electrode PE is placed above the first substrate 12. In other words, the display panel 10 is a horizontal electric field type liquid crystal display.

The second substrate 14 is located on the front surface side of the first substrate 12. The second substrate 14 is rectangular in plan view and one second substrate 14 is provided for a plurality of the sub-pixels SP. A color filter CF and a light-shielding film SM are placed on, and an orientation film AL is placed under the rear surface of the second substrate 14. The light-shielding film SM and the color filter CF are placed between the second substrate 14 and the orientation film AL.

The color filter CF is rectangular in plan view and one color filter CF is placed for one sub-pixel SP. The color filter CF is translucent, and the peak of the spectrum of light to be transmitted is predetermined. The peak of the spectrum corresponds to the color of the color filter CF. The color of the color filter CF is the same as that of the sub-pixel SP. In other words, the red first sub-pixel SP1 has a red color filter CF, the green second sub-pixel SP2 has a green color filter CF, and the blue third sub-pixel SP3 has a blue color filter CF.

The light-shielding film SM is lightproof and demarcates the sub-pixels SP. In other words, the light-shielding film SM overlaps in plan view the boundaries of the sub-pixels SP that are adjacent to each other in the X and Y directions. In FIG. 4, the signal line Lb and the scanning line Lc are omitted.

The liquid crystal layer 13 includes a plurality of liquid crystal molecules LM. The liquid crystal layer 13 is present between the first substrate 12 and the second substrate 14 and overlaps the display region DA in plan view. Specifically, the liquid crystal layer 13 is present between two orientation films AL facing each other. The orientation of the liquid crystal molecules LM is regulated by the two orientation films AL facing each other.

As illustrated in FIGS. 2 and 4, the display panel 10 further includes a first polarizing plate 15 placed on the rear surface of the first substrate 12 and a second polarizing plate 16 placed on the front surface of the second substrate 14.

The first polarizing plate 15 has a transmission axis orthogonal to the Z direction. The second polarizing plate 16 has a transmission axis orthogonal to the transmission axis of the first polarizing plate 15 and the Z direction.

As illustrated in FIGS. 1 and 2, the first substrate 12 has an exposed portion 12b that is exposed from the second substrate 14 in plan view. The exposed portion 12b is on the +X side of the second substrate 14 in plan view. An IC chip Ti including the drive circuit 11 is placed on the front surface of the exposed portion 12b. The front surface of the exposed portion 12b is part of the main surface 12a of the first substrate 12. The drive circuit 11 is located outside (specifically on the +X side) of the display region DA in plan view.

The drive circuit 11 outputs sub-pixel signals to the sub-pixels SP on the basis of image signals, thereby generating an electric field in the liquid crystal layer 13 and changing the orientation of the liquid crystal molecules LM. Thus, the light transmitted through the display panel 10 is modulated, to display an image.

As illustrated in FIG. 2, the light source device 20 is placed on the rear surface side of the display panel 10. The light source device 20 emits light (hereinafter described as emitted light) toward the display panel 10. The light source device 20 is, for example, a direct-lit backlight and has a plurality of light-emitting diodes (not illustrated).

As illustrated in FIGS. 1 and 2, the color separation element 30 is a rectangular plate in plan view. The color separation element 30 is larger than the display panel 10 in plan view. The periphery of the color separation element 30 is located outside of the periphery of the display panel 10 in plan view. Part of the color separation element 30 may be located outside of the display panel 10 in plan view.

As illustrated in FIG. 2, the color separation element 30 is placed between the display panel 10 and the light source device 20. The color separation element 30 is translucent, and the emitted light from the light source device 20 enters the display panel 10 through the color separation element 30.

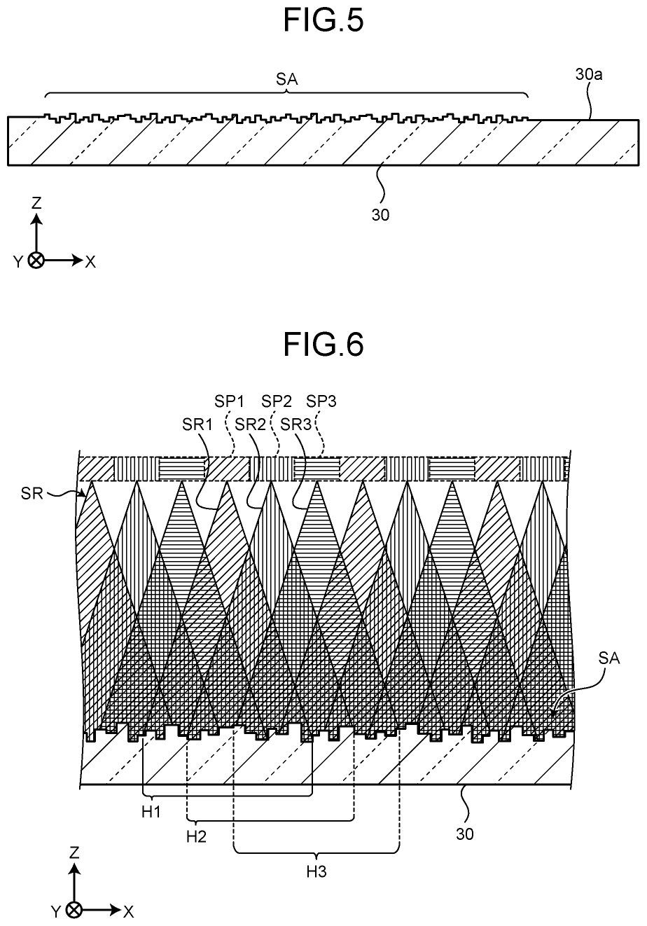

FIG. 5 is a sectional view of the color separation element 30. FIG. 6 is an enlarged sectional view of the color separation element 30. The color separation element 30 disperses the emitted light from the light source device 20 and emits, to the pixel P, a plurality of rays of separated light SR with wavelengths different from each other. The color separation element 30 has a separation region SA that emits the separated light SR. The separation region SA is on the board surface of the color separation element 30 (front surface of the color separation element 30; hereinafter may be described as an emitting surface 30a) facing the display panel 10 and overlaps the display region DA in plan view.

As illustrated in FIG. 6, the separated light SR emitted from the separation region SA includes first separated light SR1 in red, the same color as the color of the first sub-pixel SP1, second separated light SR2 in green, the same color as the second sub-pixel SP2, and third separated light SR3 in blue, the same color as the third sub-pixel SP3. In the separation region SA, the front surface of the color separation element 30 has a given uneven shape.

The given uneven shape is such that the first separated light SR1 gathers in the first sub-pixel SP1 from a first range H1, which is larger than the first sub-pixel SP1 in plan view and overlaps the first sub-pixel SP1 in plan view. The given uneven shape is such that the second separated light SR2 gathers in the second sub-pixel SP2 from a second range H2, which is larger than the second sub-pixel SP2 in plan view and overlaps the second sub-pixel SP2 in plan view. Furthermore, the given uneven shape is such that the third separated light SR3 gathers in the third sub-pixel SP3 from a third range H3, which is larger than the third sub-pixel SP3 in plan view and overlaps the third sub-pixel SP3 in plan view.

There are a plurality of the first ranges H1 corresponding to the first sub-pixels SP1. There are a plurality of the second ranges H2 corresponding to the second sub-pixels SP2. There are a plurality of the third ranges H3 corresponding to the third sub-pixels SP3. The first range H1, the second range H2, and the third range H3 have portions overlapping each other in plan view.

In this manner, the color separation element 30 separates the emitted light from the light source device 20 for each wavelength corresponding to the color of the individual color filter CF, and causes the light (separated light SR) with the wavelength corresponding to the color filter CF to enter and be transmitted through the color filter CF. Thus, the loss of quantity of the emitted light from the light source device 20 can be suppressed and the utilization efficiency of the emitted light can be increased compared to a case in which the display device 1 does not include the color separation element 30 and the emitted light from the light source device 20 directly enters the display panel 10.

As illustrated in FIG. 2, the adhesive portion 40 is present between the display panel 10 and the color separation element 30. The adhesive portion 40 bonds the display panel 10 to the color separation element 30. As illustrated in FIG. 1, the adhesive portion 40 is present between the peripheries of the display region DA and the separation region SA and the periphery of the first substrate 12 in plan view. Specifically, the adhesive portion 40 is placed around the entire perimeter of the display region DA in plan view. That is, the adhesive portion 40 is continuously placed around the display region DA without interruption in plan view. The first polarizing plate 15 is inside the adhesive portion 40 in plan view. The adhesive portion 40 is in continuous contact with the color separation element 30 in plan view around the entire perimeter of the display region DA.

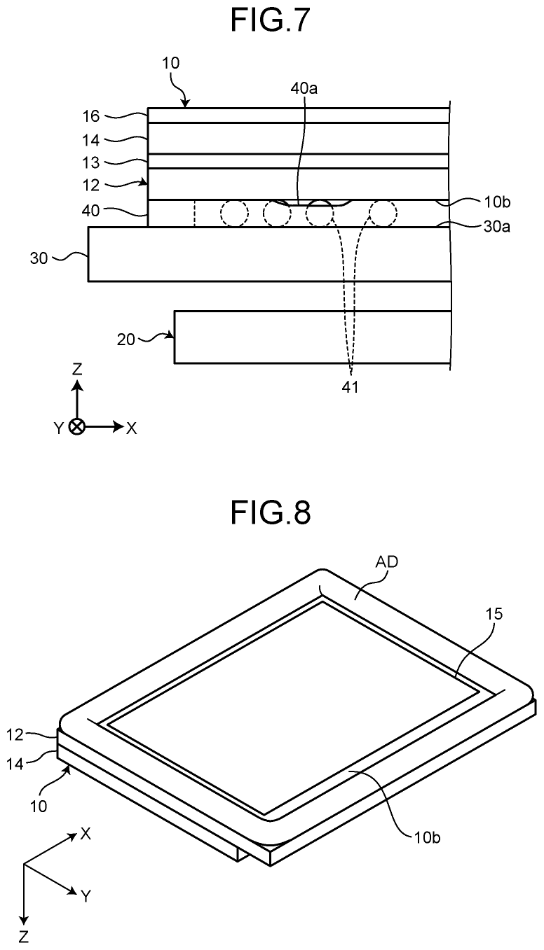

FIG. 7 is a side view of the display device 1. The adhesive portion 40 has a recessed portion 40a that is separated from the display panel 10 in side view. The recessed portion 40a causes the space inside of the adhesive portion 40 to communicate with the space outside of the adhesive portion 40 in plan view between the display panel 10 and the color separation element 30. The depth of the recessed portion 40a and the width of the recessed portion 40a are set to such sizes that suppress the entry of foreign matter (such as dust) into the space inside of the adhesive portion 40 (details will be described below). Although there is one recessed portion 40a in the present embodiment, there may be a plurality of the recessed portions 40a.

The adhesive portion 40 is formed by an adhesive. The adhesive is a one-part adhesive and, for example, an ultraviolet (UV) curable adhesive.

As illustrated in FIGS. 2 and 7, the adhesive portion 40 contains a plurality of gap members 41 of a given size. The gap member 41 is spherical, for example, and has a given diameter corresponding to the given size. In the present embodiment, the given diameter is approximately 160 μm. The ratio of the total volume of the gap members 41 to the volume of the adhesive portion 40 is approximately 2%. The gap member 41 has a state in which all of the gap member 41 is covered by the adhesive portion 40 and a state in which part of the gap member 41 is exposed from the adhesive portion 40.

The hardness of the gap member 41 is higher than that of the adhesive portion 40. Therefore, the gap member 41 is less deformable to external forces than the adhesive portion 40.

The gap member 41 is sandwiched by the opposite surface 10b of the display panel 10 and the emitting surface 30a of the color separation element 30. Thus, the distance in the Z direction between the display panel 10 and the color separation element 30 is substantially constant at the given diameter. The given diameter is defined as the size at which the separated light SR gathers in the sub-pixel SP.

The gap members 41 are contained in the adhesive in advance. Specifically, the gap members 41 are mixed with the adhesive before manufacturing of the display device 1 is started.

Method for Manufacturing Display Device 1

A bonding process for bonding the display panel 10 to the color separation element 30 in a method for manufacturing the display device 1 will be described next.

The bonding process includes an application step of applying the adhesive to the display panel 10, a sticking step of sticking together the color separation element 30 and the display panel 10, a pressing step of applying force to the display panel 10 and the color separation element 30, a first curing step of curing part of the adhesive, an unloading step of removing the force, and a second curing step of curing the entire adhesive. The application step, the sticking step, the pressing step, and the first curing step, the unloading step, and the second curing step are performed in this order.

FIG. 8 is a perspective view illustrating the display panel 10 to which the adhesive AD has been applied at the application step. At the application step, the adhesive AD is applied around the entire perimeter of the first polarizing plate 15 on the opposite surface 10b of the display panel 10. In other words, at the application step, the adhesive AD containing the gap members 41 of the given size is applied to the board surface (opposite surface 10b) of the display panel 10. The adhesive AD is applied using a dispenser.

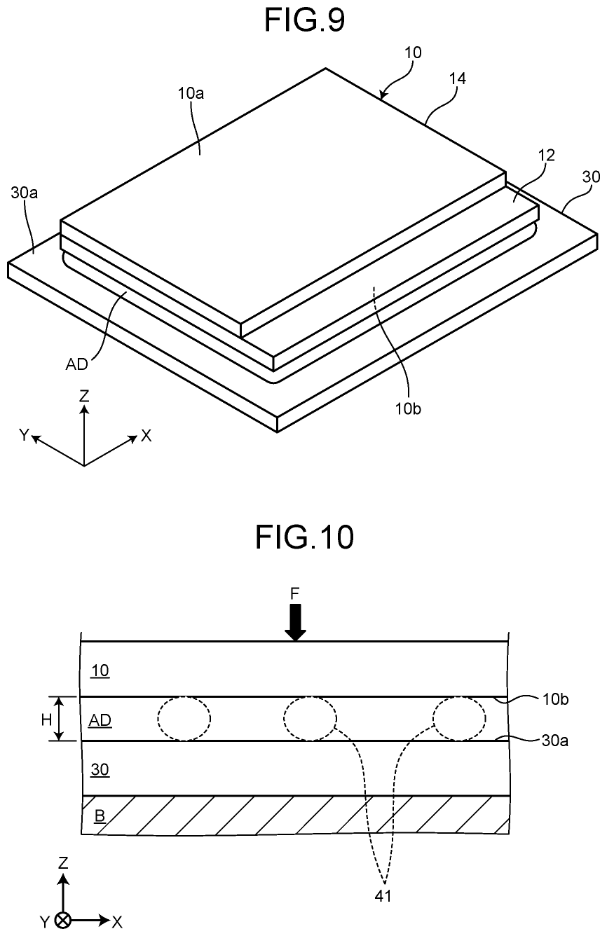

FIG. 9 is a perspective view illustrating the color separation element 30 and the display panel 10 being stuck together at the sticking step. At the sticking step, the board surface (emitting surface 30a) of the color separation element 30 and the opposite surface 10b of the display panel 10 on which the gap members 41 have been sprinkled are stuck together with the adhesive AD therebetween. At the sticking step, the gap members 41 are sandwiched by the board surface (emitting surface 30a) of the color separation element 30 and the opposite surface 10b of the display panel 10. At this time, the adhesive AD is in continuous contact with both the display panel 10 and the color separation element 30 in side view around the entire perimeter of the display region DA.

FIG. 10 is a side view illustrating force F being applied to the display panel 10 and the color separation element 30 at the pressing step. At the pressing step, the force F is applied to press the gap members 41 against the color separation element 30 and the display panel 10, which have been stuck to each other with the adhesive AD therebetween. Specifically, with the color separation element 30 placed on a stand B, the force F is applied to the display panel 10 toward the color separation element 30 side. Thus, the gap members 41 are elastically deformed and a distance H in the Z direction between the display panel 10 and the color separation element 30 is smaller than the given diameter of the gap members 41.

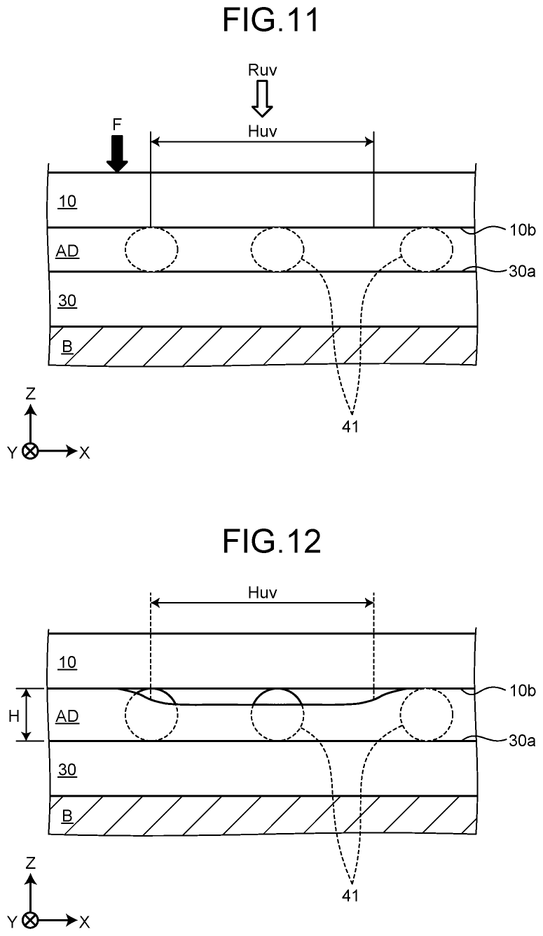

FIG. 11 is a side view illustrating part of the adhesive AD being irradiated with UV light Ruv at the first curing step. At the first curing step, part of the adhesive AD is cured while the force F is applied to the color separation element 30 and the display panel 10. Specifically, a section of the adhesive AD that is in contact with the display panel 10, that is, a section on the display panel 10 side in part of the adhesive AD, is cured.

At the first curing step, part of the adhesive AD is irradiated with the UV light Ruv from the display panel 10 side while the force F is applied. The UV light Ruv is emitted to an irradiation range Huv. That is, the range of the part of the adhesive AD corresponds to the irradiation range Huv of the UV light Ruv.

At the first curing step, the integrated light quantity of the UV light Ruv is a predetermined first given integrated light quantity. The first given integrated light quantity is the integrated light quantity in which the section of the adhesive AD on the display panel 10 side that is in contact with the display panel 10 cures. The first given integrated light quantity is derived from an experiment or the like conducted in advance. The first given integrated light quantity is, for example, 1000 mJ/cm².

When the part of the adhesive AD is irradiated with the UV light Ruv, the section on the display panel 10 side in part of the adhesive AD cures. On the contrary, a section of the entire adhesive AD on the color separation element 30 side that is in contact with the color separation element 30 in part of the adhesive AD, and sections other than the part of the adhesive AD do not cure.

FIG. 12 is a side view illustrating the force F removed from the display panel 10 and the color separation element 30 at the unloading step. At the unloading step, the force F is removed while part of the adhesive AD (specifically, the section on the display panel 10 side in part of the adhesive AD) has cured.

When the force F is removed while part of the adhesive AD has cured, the gap members 41, which were elastically deformed by the force F, return to their original shapes. Thus, as the display panel 10 is lifted by the gap members 41 and the display panel 10 is moved away from the color separation element 30, the distance H in the Z direction becomes substantially equal to the given diameter of the gap members 41, and part of the adhesive AD is separated from the display panel 10.

On the contrary, the sections of the adhesive AD other than the section on the display panel 10 side in part of the adhesive AD are not cured and are in contact with the display panel 10, following the movement of the display panel 10. Thus, part of the adhesive AD corresponding to the irradiation range Huv is recessed.

Subsequently, at the second curing step, the entire adhesive AD is cured while the force F is removed from the color separation element 30 and the display panel 10. Specifically, the entire adhesive AD is irradiated with the UV light Ruv. At the second curing step, the integrated light quantity of the UV light Ruv is a predetermined second given integrated light quantity. The second given integrated light quantity is smaller than the first given integrated light quantity and is the integrated light quantity that ensures the curing of the entire adhesive AD. The second given integrated light quantity is derived from an experiment or the like conducted in advance. The second given integrated light quantity is, for example, 250 (mJ/cm²).

The wavelength of the UV light Ruv at the second curing step may be longer than the wavelength of the UV light Ruv at the first curing step. When the wavelength of the UV light Ruv is long, the UV light Ruv reaches the entire adhesive AD in the Z direction, ensuring the curing of the entire adhesive AD.

When the entire adhesive AD cures with part of the adhesive AD being recessed at the second curing step, the adhesive portion 40 having the recessed portion 40a is formed. Because the first given integrated light quantity is greater than the second given integrated light quantity as described above, the color of part of the adhesive AD is more yellowish than the color of sections other than the part of the adhesive AD, and the color of the sections other than the part of the adhesive AD is more whitish than the color of the part of the adhesive AD.

As described above, the recessed portion 40a causes the space inside of the adhesive portion 40 to communicate with the space outside of the adhesive portion 40 in plan view between the display panel 10 and the color separation element 30. Therefore, deformation of the display panel 10 and the color separation element 30 due to the force created by air compression is suppressed in the space inside of the adhesive portion 40.

The depth of the recessed portion 40a is very small, substantially equal to the amount of elastic deformation of the gap members 41 during the pressing step. In the present embodiment, the depth of the recessed portion 40a is approximately equal to or less than 10 μm. Therefore, the entry of foreign matter through the recessed portion 40a can be suppressed.

The width of the recessed portion 40a is determined by the irradiation range Huv of the UV light Ruv. The irradiation range Huv is defined so that the opening area of the recessed portion 40a is set to such a size that suppresses the passage of foreign matter. Consequently, the entry of foreign matter through the recessed portion 40a can be suppressed securely.

Modification of Method for Manufacturing Display Device 1

For example, the second curing step may be performed between the pressing step and the first curing step. In other words, in this case, the bonding process is performed in the following order: the application step, the sticking step, the pressing step, the second curing step, the first curing step, and the unloading step.

In this case, at the second curing step, the entire adhesive AD is irradiated with the UV light Ruv in the second given integrated light quantity while the force F is applied to the color separation element 30 and the display panel 10. Subsequently, the first curing step is performed before the entire adhesive AD completely cures. In other words, part of the adhesive AD is irradiated with the UV light Ruv in the first given integrated light quantity from the display panel 10 side while the force F is applied to the color separation element 30 and the display panel 10. With this operation, part of the adhesive AD cures before the entire adhesive AD completely cures.

Furthermore, before the entire adhesive AD completely cures, the unloading step is performed, which causes part of the adhesive AD to be recessed. As the entire adhesive AD completely cures, the adhesive portion 40 having the recessed portion 40a is formed.

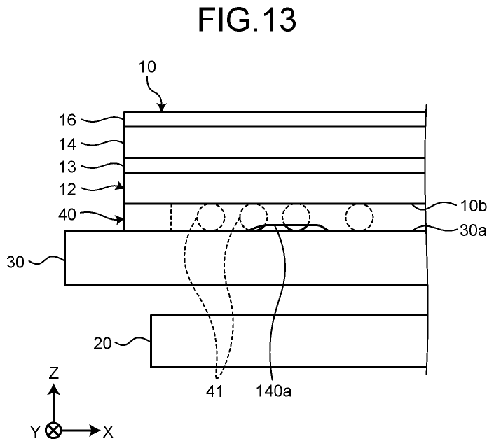

FIG. 13 is a side view illustrating the display device 1 according to a modification of the embodiment of the present disclosure. In the present modification, a recessed portion 140a that the adhesive portion 40 has is separated from the color separation element 30 in side view. In this case, the adhesive portion 40 is in continuous contact with the display panel 10 in side view around the entire perimeter of the display region DA.

In this case, at the first curing step, part of the adhesive AD is irradiated with the UV light Ruv from the color separation element 30 side while the force F is applied to the color separation element 30 and the display panel 10. With this operation, a section on the color separation element 30 side that is in contact with the color separation element 30 in part of the adhesive AD cures.

Part of the adhesive AD that has cured at the first curing step (specifically, the section on the color separation element 30 side in part of the adhesive AD) is separated from the color separation element 30 and recessed at the unloading step. Furthermore, the entire adhesive AD cures at the second curing step, thereby forming the recessed portion 140a.

At the first curing step, part of the adhesive AD may be cured in its entirety. In this case, both the section that is in contact with the display panel 10 and the section that is in contact with the color separation element 30 cure in part of the adhesive AD. Furthermore, in this case, part of the adhesive AD is separated from one or both of the display panel 10 and the color separation element 30 at the unloading step. When the entire adhesive AD cures at the second curing step, one or both of the recessed portion 40a (FIG. 7), which is separated from the display panel 10, and the recessed portion 140a (FIG. 13), which is separated from the color separation element 30, are formed.

The first given integrated light quantity and the second given integrated light quantity may be an equal integrated light quantity.

It is understood that any other effects brought about by the modes described in the embodiments that are obvious from the description of the present specification or that would be conceived of by a person skilled in the art are naturally brought about by the present disclosure.

What is claimed is:

1. A display device comprising:
a display panel;
a color separation element configured to disperse light from a light source and to emit, to the display panel, a plurality of rays of separated light with wavelengths different from each other; and
an adhesive portion that contains a gap member of a given size and that bonds the display panel to the color separation element, wherein
the adhesive portion has a recessed portion that is separated from one of the display panel and the color separation element in side view.

2. The display device according to claim 1, wherein the gap member is sandwiched by the display panel and the color separation element.

3. The display device according to claim 1, wherein
the display panel has a display region where an image is displayed, and
the adhesive portion is placed around an entire perimeter of the display region in plan view.

4. A method for manufacturing a display device, the method comprising:
applying an adhesive containing a gap member of a given size to a board surface of a display panel;
sticking together a board surface of a color separation element and the board surface of the display panel with the adhesive between the board surfaces, the board surface of the color separation element dispersing light from a light source and emitting a plurality of rays of separated light with wavelengths different from each other;
applying force to press the gap member against the color separation element and the display panel, the color separation element and the display panel being stuck to each other with the adhesive;
curing part of the adhesive while the force is applied to the color separation element and the display panel;
removing the force while the part of the adhesive has cured; and
curing the entire adhesive while the force is removed from the color separation element and the display panel.

5. The method for manufacturing a display device according to claim 4, wherein
the adhesive is an ultraviolet (UV) curable adhesive, and
at the curing part of the adhesive, part of the adhesive is irradiated with UV light from one side of the display panel and the color separation element.

6. The method for manufacturing a display device according to claim 4, wherein
at the curing part of the adhesive, part of the adhesive is cured in a first given integrated light quantity, and
at the curing the entire adhesive, the entire adhesive is cured in a second given integrated light quantity that is smaller than the first given integrated light quantity.
